(19) United States
(12) Patent Application Publication
(10) Pub. No.: US 2013/0122456 A1
(43) Pub. Date: May 16, 2013

(54) DRILLING DEVICE

(71) Applicant: Akira TAKEBAYASHI, Saitama (JP)

(72) Inventor: Akira TAKEBAYASHI, Saitama (JP)

(21) Appl. No.: 13/671,592

(22) Filed: Nov. 8, 2012

(30) Foreign Application Priority Data
Nov. 15, 2011 (JP) 2011-249404
Sep. 17, 2012 (JP) 2012-203772

(51) Int. Cl. A61C 8/00

(52) U.S. Cl. CPC A61C 8/0089
USPC 433/75

(57) ABSTRACT

Provided is a drilling device having a simple configuration, and being less likely to cause errors in drilling direction even when the bone density of the cancellous bone to be drilled is non-uniform. A drilling device includes a drill having a central hole formed from a front end along a rotation axis, and a guide pin inserted in the central hole from the front end, wherein the drilling direction thereof is determined by a guide pin embedded either in an embedding hole formed by a pilot hole drilling device or an embedding hole formed by a drill in one previous step.

### TECHNICAL FIELD

The present invention relates to a drilling device used for drilling an embedding hole, in which a fixture of a dental implant is to be embedded, in an alveolar bone of a patient.

### BACKGROUND

A dental implant (hereinafter simply referred to “implant”) used for implant treatment is made up of a fixture, an abutment, and a superstructure.

The fixture may be also referred to implant body, and made of titanium, for example. The fixture is embedded in an alveolar bone of a patient at which a tooth is missing. The abutment is coupled to the fixture to become a support. The superstructure may also be referred to artificial tooth crown, and is attached to cover the abutment.

In implant treatment, it is important that an embedding hole, into which a fixture is to be embedded, is drilled accurately at a predetermined position in an alveolar bone of the patient. (See JP-A-2001-170080, for example).

The embedding hole is drilled by using multiple drilling devices. Firstly, a hole having a small diameter is formed by a pilot drill. Then, the hole is enlarged stepwise by using multiple drills (multiple steps), each of the drill having a diameter larger than a previous drill. Finally, the hole is further drilled by using a final drill that has a cutting portion having a shape substantially same as that of the fixture so that the hole becomes an embedding hole having a diameter substantially same as the diameter of the fixture.

In the process of enlarging the diameter of the embedding hole stepwise, a previously drilled hole becomes a guide hole to be used for a drill that is used in a subsequent drilling. Therefore, when the bone density of the cancellous bone to be embedded is substantially uniform, the embedding hole drilled by the final drill becomes accurate if the hole firstly drilled by the pilot drill is accurate. In other words, as long as the first hole formed by the pilot drill is drilled accurately to a predetermined depth in a predetermined direction, there is almost no possibility that a big difference (deviation) occurs in drilling direction when the hole is enlarged stepwise to a predetermined diameter by using drills, even though a surgical guide is not used.

However, if the bone density of the cancellous bone to be drilled is non-uniform, differences in normal force (the force toward the radial direction of the drill) exerted from the cancellous bone during the drilling may cause the front end of the drill to drive toward a portion of the cancellous bone having a smaller bone density. This may often result in a big difference (deviation) in drilling direction of the embedding hole.

To address the issue, methods have been adopted such as:

(1) to increase the number of steps of changing the drill to a drill having a larger diameter, or

(2) to use a surgical guide for every drill of each diameter.
Prior Art Document: JP-A-2001-170080

### SUMMARY

### Problems to be Solved by the Invention

However, in these conventional methods, there were problems such as:

(1) the increase of steps increases the number of drills or surgical guides to be used, and also the amount of time for the surgery, and

(2) these methods are not effective even when a surgical guide is used, if the bone density of the cancellous bone is significantly non-uniform.

The present invention therefore aims to provide a drilling device having a simple configuration, and being less likely to cause errors in drilling direction,

(1) without increasing the number of steps for drills or surgical guides, and

(2) even when the bone density of the cancellous bone is significantly non-uniform.

### Means for Solving the Problems

The invention according to claim 1 is characterized in a drilling device used in a process of drilling an embedding hole, into which a fixture of a dental implant is to be embedded, in an alveolar bone of a patient, and used for enlarging a hole, which is previously drilled to a predetermined diameter in a predetermined direction by a pilot hole drilling device, stepwise to a predetermined diameter. The drilling device comprises a drilling device body having a central hole formed from a front end toward a base end along a rotation axis, and a guide pin inserted into the central hole from the front end. The guide pin is embedded in the embedding hole drilled by the pilot hole drilling device or by a drilling device body in one previous step. The central hole of the drilling device body is fitted with the guide pin and then drilling is performed, thereby the drilling direction is limited to the direction of the guide pin being embedded in.

The invention according to claim 2 is characterized in that, in the drilling device according to claim 1, the length of the guide pin is set to a length greater than the depth of the embedding hole previously drilled by the pilot hole drilling device.

The invention according to claim 3 is characterized in that, in the drilling device according to claim 1, the diameter of the guide pin is set to a magnitude that matches with the diameter of the embedding hole drilled by the pilot hole drilling device or by the drilling device body in one previous step.

The invention according to claim 4 is characterized in that, in the drilling device according to any of claim 1, the length of the guide pin is set to a length greater than the length of the central hole.

The invention according to claim 5 is characterized in that, in the drilling device according to any of claim 1, the diameter of the guide pin is set with respect the diameter of the central hole to allow the guide pin to smoothly slide in the central hole along the rotation axis.

The invention according to claim 6 is characterized in that, in the drilling device according to any of claim 1, a scale is provided on a surface of the guide pin for indicating the length of a portion of the guide pin being embedded in the bone when the guide pin is embedded in the embedding hole.

The invention according to claim 7 is characterized in that, in the drilling device according to any of claim 1, the drilling device body comprises a water injection hole formed along the rotation axis from the base end into the central hole.

The invention according to claim 8 is characterized in that, in the drilling device according to any of claims 1 to 7, the drilling device body is a twist drill.

The invention according to claim 9 is characterized in that, in the drilling device according to any of claims 1 to 7, the drilling device body is a reamer that has a cutting portion having a shape substantially same as that of the fixture.

### Effect of the Invention

According to the invention of claim 1, since the drilling is performed in a state that the central hole of the drilling device body goes along the guide pin that is embedded in the embedding hole drilled by the pilot hole drilling device or by a drilling device body in one previous step, the embedding hole for the fixture can be drilled accurately at a predetermined position in the mouth of the patient, by enlarging the embedding hole previously drilled by the pilot hole drilling device without causing errors in the drilling direction of the drilling device body, even when the bone density of the cancellous bone is significantly non-uniform.

In other words, a dental drill having a simple configuration can be provided,

(1) without increasing the number of steps for drills or surgical guides, and

(2) being effective even when the bone density of the cancellous bone is significantly non-uniform.

The provided drill is used when the embedding hole previously drilled by the pilot hole drilling device is enlarged to a predetermined depth in a predetermined direction, and the drill is less likely to cause errors in drilling direction.

According to the invention of claim 2, the guide pin that is embedded in the embedding hole previously drilled by the pilot hole drilling device can be readily inserted into the central hole of the drilling device body.

According to the invention of claim 3, the guide pin can be closely embedded without looseness in the embedding hole drilled by the pilot hole drilling device or by the drilling device body in one previous step.

According to the invention of claim 4, since the base end of the guide pin abuts the bottom of the central hole when the embedding hole is drilled a drill, the drilling by the drill deeper than the predetermined depth (the depth of the embedding hole drilled by the pilot hole drilling device) can be prevented.

According to the invention of claim 5, a drill can drill the hole accurately and smoothly along the guide pin.

According to the invention of claim 6, the depth of the embedding hole can be checked by the scale provided on the surface of the guide pin.

According to the invention of claim 7, poring water in the water injection hole can prevent the guide pin from floating upward.

According to the invention of claim 8, a twist drill having a cutting edge on a front end thereof can be used as the drilling device body.

According to the invention of claim 9, a reamer having a cutting edge on a side surface thereof can be used as the drilling device body.

### BRIEF DESCRIPTION OF THE DRAWINGS

FIG. 1 is a front view of a drill DR and a guide pin GP of a drilling device BE1 of a first embodiment, illustrating a cross sectional view taken along a plane that includes a rotation axis C, and showing a right half portion of the drill DR.

FIGS. 2A to 2C illustrate states of the drilling device BE1 of the first embodiment being used.

FIG. 3 is a vertical cross sectional view illustrating an implant 70.

FIGS. 4A to 4E are schematic views illustrating an example in which an embedding hole HA having a truncated cone shaped lower end portion is formed by using a device 42 with a piezo chip.

FIGS. 5A to 5F are schematic views illustrating an example in which an embedding hole HA having a truncated cone shaped lower end portion is formed by using a reamer as a device 43.

FIGS. 6A to 6E illustrate states of a drilling device BE2 of a second embodiment being used.

### EMBODIMENTS FOR IMPLEMENTING THE INVENTION

Embodiments to which the present invention is applied are described based on the drawings. Same reference numerals are used throughout the drawings to designate like or equivalent members, and duplicating descriptions thereof are omitted. In addition, members that are not essential for the description are omitted in the drawings as appropriate.

### First Embodiment

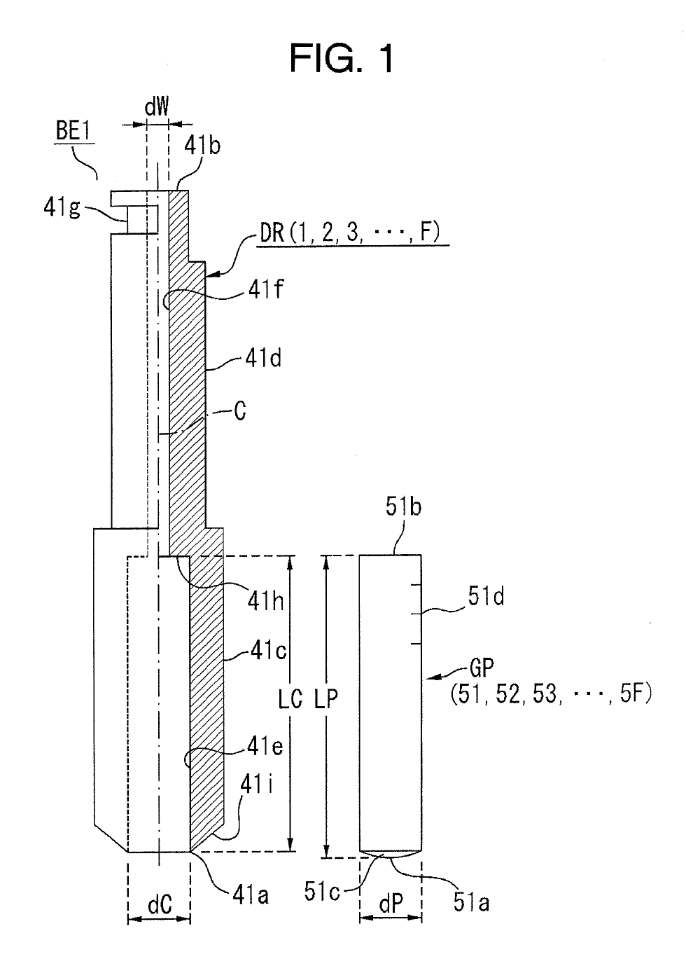

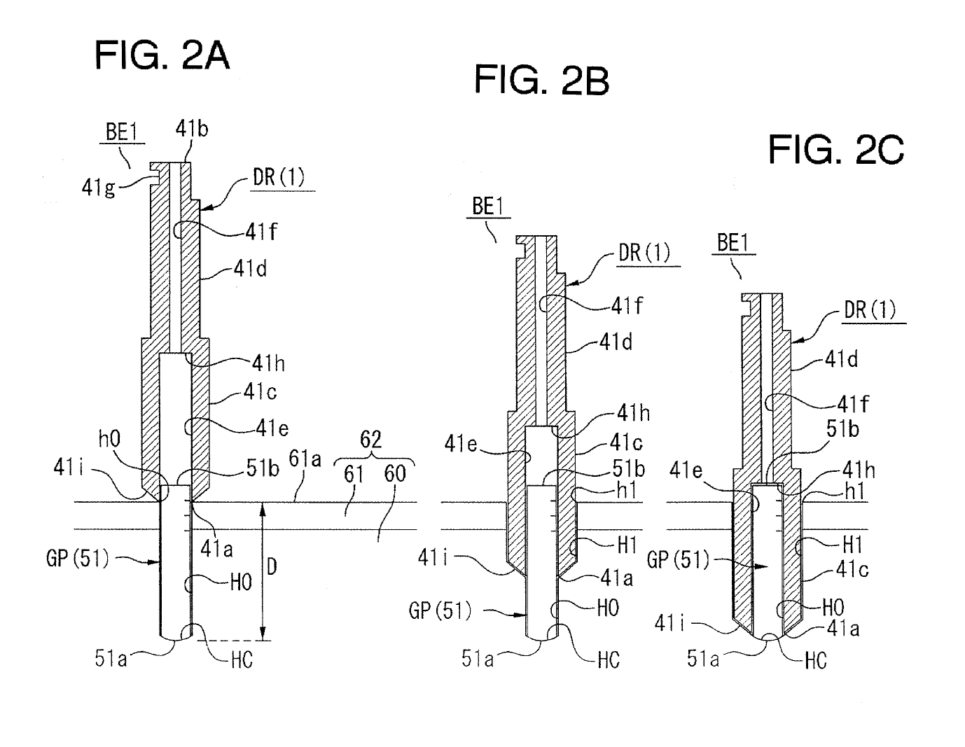

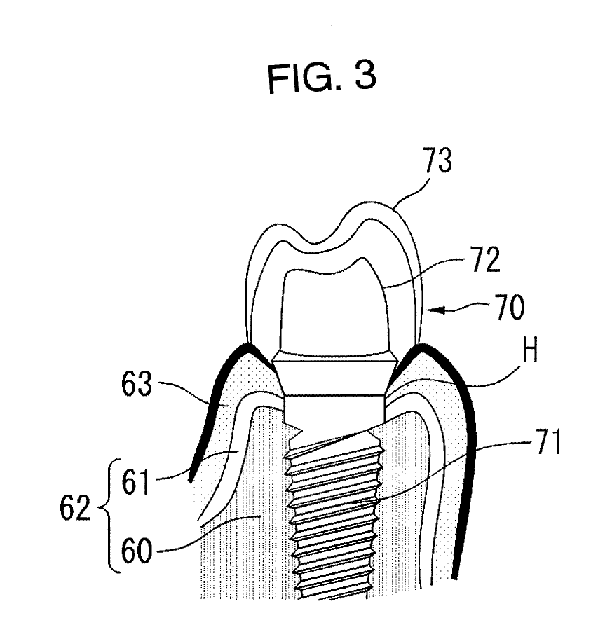

With reference to FIG. 1, FIGS. 2A to 2C, and FIG. 3, a drilling device BE1 according to a first embodiment to which the present invention is applied is described.

The drilling device BE1 of the present embodiment comprises a dental twist drill DR (Hereinafter simply referred to “drill”.) as a drilling device body and a guide pin GP.

FIG. 1 is a front view of the drill DR of the drilling device BE1 and the guide pin GP. FIG. 1 illustrates a cross section taken along a plane including a rotation axis C, and shows a right half portion of the drill DR.

FIG. 2A, FIG. 2B, and FIG. 2C illustrate states of the drilling device BE1 being used. FIG. 2A shows a state when the drilling is started. FIG. 2B shows a state during the drilling (in-progress). FIG. 2C shows a state when the drilling is completed.

FIG. 3 is a vertical cross sectional view illustrating an implant 70.

### I. Overall Summary

With reference to FIG. 3, the implant 70 is described. At which a tooth (not shown) is missing, an alveolar bone 62 composed of a soft cancellous bone 60 and a hard the cortex bone 61, and a mucosa (gingival) 63 that covers the alveolar bone 62 remain.

The implant 70 includes a fixture 71, an abutment 72 and a superstructure 73. The fixture 71 is embedded in an embedding hole H drilled in the alveolar bone 62. The abutment 72 is coupled to the fixture 71 to form a support. The superstructure 73 is attached to the abutment 72.

The embedding hole H into which the fixture 71 is to be embedded may be drilled in the alveolar bone 62 as described below.

Firstly, a small hole (pilot hole) having a smallest diameter is drilled by using a pilot drill (a drill that firstly drills a hole in the alveolar bone 62) as a pilot hole drilling device. Then, the diameter of the hole is enlarged stepwise using several types (several steps) of drills DR each having a diameter greater than a drill in one previous step. Finally, a final embedding hole is drilled by using a drill DR (final drill) having a diameter substantially same as that of the fixture 71.

The present invention may be applied to a drilling device BE1, other than the pilot hole drilling device, which is used to enlarge an embedding hole H0 that is previously drilled to a predetermined depth in a predetermined direction by a pilot hole drilling device, to a predetermined diameter.

### II. The Configuration of the Drilling Device BE1

With reference now to FIG. 1 and FIG. 2, the configuration of the drilling device BE1 is described.

In the description below, an embedding hole drilled in the alveolar bone 62 by a pilot drill (not shown) as a pilot hole drilling device is defined as H0, and an opening of the embedding hole H0 is defined as h0. In addition, an embedding hole drilled by a drill 1 having a diameter one step greater than that of the pilot drill is defined as H1, and an opening thereof is defined as h1. Similarly, an embedding hole drilled by a drill 2 having a diameter two steps greater than that of the pilot drill is defined as H2, and an opening thereof is defined as h2.

Similarly, an embedding hole drilled by a drill N having a diameter N steps greater than the pilot drill is defined as HN, and an opening thereof is defined as hN (where N=1, 2, 3, . . . , F). A drill F is a final drill having a cutting portion that has a shape substantially same as that of the fixture 71. Based on these definitions, the drills DR according to the present embodiment correspond to the drill 1, drill 2, drill 3, . . . , and drill F.

Guide pins GP used together with the drills DR are described below. A guide pin 51 is used for the drill 1, a guide pin 52 is used for the drill 2, a guide pin 53 is used for the drill 3, . . . , and a guide pin 5F is used for the drill F, respectively.

The embedding hole H0 has a bottom portion HC, and a depth D. The depth D is a distance from a surface 61a of the cortex bone 61 to the bottom portion HC.

The drilling device BE1 shown in FIG. 1 is a drilling device for drilling an embedding hole H for the fixture 71. The drilling device BE1 comprises the drill DR and the guide pin GP that can be inserted in and pulled out from the drill DR.

### (i) Drill DR

The drill DR is formed to have its rotation axis (rotation central) C in the longitudinal direction. The drill DR has a cutting portion 41c in a portion nearer a front end 41a (lower side in FIG. 1), and a shank portion 41d in a portion nearer a base end 41b. The cutting portion 41c is formed substantially cylindrically. The cutting portion 41c includes a cutting edge 41i formed at the front end 41a and used for cutting. In addition, the cutting portion 41c includes a helical groove portion (not shown) on its outer periphery surface, formed for ejecting chippings that are cut by the cutting edge 41i.

The drill DR has a central hole 41e formed in the cutting portion 41c (the portion nearer the front end 41a) along the rotation axis C. In addition, a water injection hole 41f is formed in the shank portion 41d (the portion nearer the base end 41b).

The central hole 41e is formed along the rotation axis C from the front end 41a toward the base end 41b. A base end of the central hole 41e is located nearer to the cutting portion 41c from the boundary between the cutting portion 41c and the shank portion 41d, and forms a top surface 41h. The top surface 41h acts as a stopper. In other words, the top surface 41h performs the positioning of the guide pin GP when a base end 51b of the guide pin GP abuts the top surface 41h from below, as described later. The guide pin GP can be inserted in or taken out from the central hole 41e, from the front end 41a.

A length LC and a diameter dC of the central hole 41e are described after the description of the guide pin GP.

The water injection hole 41f is formed along the rotation axis C so that it pierces from the top surface 41h of the central hole 41e to the base end 41b of the drill DR. The diameter dW of the water injection hole 41f is set to be smaller than the diameter dC of the central hole 41e. When a water injection nozzle (not shown) is inserted from the base end 41b, the water injection hole 41f allows water injection into the central hole 41e.

By the water injection, the alveolar bone 62 and the drill DR are cooled when the drill DR is in a drilling operation. In addition, the water injection prevents the guide pin GP from floating upward during the drilling operation. In other words, the water injection can urge the base end 51b of the guide pin GP downward when the drill DR is used, in order to prevent a front end 51a from being separated from the bottom portion of HC of the embedding hole H0 and floating upward.

The water injection hole 41f also acts as an air vent when the central hole 41e is fitted with the guide pin GP.

The drill DR includes a notch 41g formed near the base end in the shank portion 41d. When the shank portion 41d at a portion nearer the base end 41b is inserted to a contra head (not shown) of a hand piece (not shown), and then a locking mechanism (not shown) of the hand piece is fitted with the notch 41g to be locked, the drill DR will be attached to a hand piece 40.

### (ii) Guide Pins GP (51, 52, 53, . . . , 5F)

The guide pin GP may be, for example, a metallic cylindrical member, and formed in a shape to be inserted in and closely fitted with the central hole 41e of the drill DR described above. The guide pin GP includes a curved portion 51c slightly curved in a convex shape formed at the front end 51a. The base end 51b of the guide pin GP is made into a flat surface.

On a surface of the guide pin GP, a scale 51d is provided along its longitudinal direction. The scale 51d indicates the length of a portion of the guide pin GP being embedded in the alveolar bone 62 when the guide pin GP is embedded in the embedding hole HN. This enables to check the depth of the embedding hole HN.

The length LP (a distance from the front end 51a to the base end 51b) including the curved portion 51c of the guide pin GP is set to a length being approximately 2.0 to 3.0 mm greater than the depth D of the embedding hole drilled by the pilot drill, i.e. than the length of the fixture 71 in the bone (the length embedded in the alveolar bone 62). The base end 51b will thus protrude 2.0 to 3.0 mm from an opening h0 of the embedding hole H0 when the guide pin 51 is embedded in the embedding hole H0 drilled by the pilot drill. Such a condition holds true for guide pins 52, 53, . . . , 5F, each of which has a diameter greater than that of the guide pin 51. This allows the guide pin GP to be readily fitted in the central hole 41e of the drill DR.

In addition, the diameter dP of the guide pin GP is set to a magnitude that matches with a diameter dN of the embedding hole H0 or an embedding hole HN drilled by a drill in one previous step. This enables the guide pin GP to be closely embedded without looseness into the embedding hole H0 drilled by the pilot drill or the embedding hole HN drilled by the drill in one previous step.

The dimensional relation between the length LC and the diameter dC of the central hole 41e of the drill DR described above and the length LP and the diameter dP of the guide pin GP is now described.

The length LC of the central hole 41e is set to be same as the length of a cylindrical portion of the guide pin GP after subtracting the length of the curved portion 51c (approximately 0.2 mm) from the length LP of the guide pin GP. In other words, only the curved portion 51c protrudes from the drill DR when the central hole 41e is fully fitted with the guide pin GP. With this configuration, the base end 51b of the guide pin GP abuts the top surface 41h of the central hole 41e when the drill DR is drilling the embedding hole HN, and thus the drilling by the drill DR deeper than the predetermined depth D can be prevented.

In addition, the diameter of dC of the central hole 41e is set to be slightly greater (for example, approximately 0.1 mm greater) than the diameter dP of the guide pin GP. In other words, the diameter dC is set to a magnitude so that the guide pin GP can smoothly slide along the central hole 41e when the central hole 41e is fitted with the guide pin GP. This enables the drill DR to accurately and smoothly perform the drilling along the guide pin CP.

### III. Procedure

The procedure for using the drilling device BE1 according to the present embodiment described above is now described.

(1) Prior to the use of the drill 1, the embedding hole H0 for the fixture 71 is drilled in the alveolar bone 62 in the mouth of a patient to a predetermined depth D in a predetermined embedding direction by using a pilot drill (not shown).
(2) Then, the guide pin 51 is embedded in the embedding hole H0 so that the front end 51a abuts the bottom portion HC of the embedding hole H0. As a result of this embedding, the base end 51b of the guide pin 51 protrudes 2.0 to 3.0 mm from the opening h0 of the embedding hole H0.
(3) Then, a hand piece to which the drill 1 is mounted is used to fit the central hole 41e of the drill 1 with a protruding portion of the guide pin 51 so that the front end 41a of the drill 1 abuts the opening h0 of the embedding hole H0 (see FIG. 2A). At the same time, a water injection nozzle (not shown) is inserted to the base end (upper end) of the water injection hole 41f, and water injection is started.

This completes the preparation of the drilling of the embedding hole H1 by the drill 1.

(4) Then, the drilling of the embedding hole H1 is started by rotating the drill 1.

The drill DR fitted with the guide pin 51 drills (proceeds) straight toward the bottom portion HC along the guide pin 51 without causing deviations in the drilling direction (proceeding direction), even when the bone density of the cancellous bone 60 is significantly non-uniform. In other words, the embedding hole H1 is drilled accurately in a direction same as the direction of the embedding hole H0 drilled by the pilot drill (see FIG. 2B).

(5) When the depth of the embedding hole H1 drilled by drill 1 reaches the predetermined depth D, the base end 51b of the guide pin 51 abuts the top surface 41h of the central hole 41e, thereby a further drilling (proceeding) by the drill DR can be avoided (see FIG. 2C).
(6) By manipulating the hand piece, the cutting portion 41c of the drill 1 is taken out from the embedding hole H1, and the rotation of the drill 1 is stopped. This completes the drilling of the embedding hole H1 by the drill 1.
(7) Then, similar drillings are repeated by sequentially changing the drills 2, 3, . . . , and F, each having a diameter stepwise greater than the diameter of the drill 1 described above, and the guide pins 52, 53, . . . , each having a diameter stepwise greater than the diameter of the guide pin 51 described above. This enables the diameter of the embedding hole H to be enlarged stepwise. Finally, the embedding hole H of a predetermined diameter can be drilled by using the drill F (final drill) and the guide pin 5F to complete the drilling of the embedding hole H.

### IV. Advantage

With the drill DR according to the present embodiment, although it has a simple configuration, the embedding hole H0 previously drilled to a predetermined depth D in a predetermined direction by the pilot drill can be enlarged stepwise to a predetermined diameter without causing errors (deviations) in drilling direction so that the embedding hole H can be drilled in a predetermined position,

(1) without increasing the number of steps for the drills and surgical guides, and

(2) even when the bone density of the cancellous bone 60 is significantly non-uniform.

In the description above, the embedding hole having a predetermined diameter is drilled by enlarging the diameter of the embedding hole stepwise by repeating similar drillings by sequentially changing from the drill 1 to drills 2, 3, . . . , and finally to the drill F (final drill), each having a diameter greater than one previous drill.

Alternatively, a drill F (final drill) having a cutting portion that has a shape substantially same as that of the fixture 71 can be used from the first. In this case, however, the rotation speed of the drill F needs to be lowered to suppress heat generation.

In addition, in the description above, the drill 1 is used immediately after the drilling by the pilot drill. Alternatively, immediately after the drilling by the pilot drill, a drilling may be performed by using another drill having a diameter greater than that of the pilot drill but smaller than that of the drill 1, and then the drill 1 may be used after that.

In addition, instead of the pilot drill, a piezo device having a diameter of 0.7 to 2.6 mm can also be used as a pilot hole drilling device. In this case, only the hard the cortex bone 61 may be drilled by the pilot drill, and then the cancellous bone 60, which is softer than the bone 61, may be drilled by using the piezo device.

In implant treatment, it is preferable that the embedding hole H for the fixture 71 has a requisite minimum size.

Therefore, a fixture 71A having a truncated cone shaped tapered portion whose front end side (lower end) is narrowed may be used. Corresponding to the shape of the fixture 71A, an embedding hole 71A having a truncated cone shaped lower end (bottom portion HC) may be drilled.

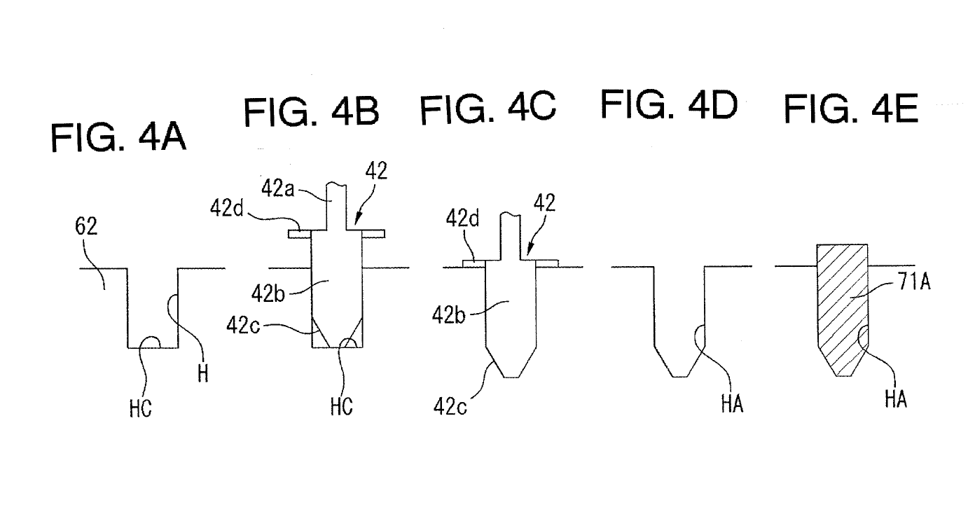

FIG. 4A to FIG. 4E are schematic views illustrating an example in which an embedding hole HA having a truncated cone lower end (bottom portion) is formed by a device 42 comprising a piezo chip.

The device 42 includes a shank portion 42a, a cylindrical portion 42b, and a truncated cone portion 42c. The outer periphery surface of the cylindrical portion 42b is smoothly formed so that the device 42 can be smoothly inserted in or taken out from the embedding holes H, HA. In addition, the base end portion of the cylindrical portion 42b includes a protruding stopper 42d. The truncated cone portion 42c has a shape substantially same as that of the tapered portion of the fixture 71A, and a diamond-coated piezo chip is provided the periphery of the portion 42c.

The device 42 is attached to a hand piece via the shank portion 42a. The piezo chip is capable of cutting the alveolar bone by ultrasonically vibrating without rotation. In a device 42, the truncated cone portion 42c corresponds to a cutting edge.

The device 42 may be used as described below.

As shown in FIG. 4A, in a case where the device 42 is used, the depth of the embedding hole H, for example, drilled by the drill F (final drill) described above is made shallower than a predetermined depth. This is done because the depth of the embedding hole H after the device 42 is used will become the predetermined depth.

The device 42 is inserted in the embedding hole H so that the tip of the truncated cone portion 42c abuts the bottom portion HC (FIG. 4B). By ultrasonically vibrating the piezo chip, a cutting operation starts. This condition continues until the stopper 42d abuts the surface of the alveolar bone 62 (FIG. 4C). After that, the ultrasonic is stopped, and the device 42 is taken out from the embedding hole HA. This allows the formation of the embedding hole HA having a truncated cone shaped bottom portion and having a predetermined depth (FIG. 4D).

The fixture 71A having a truncated cone shaped lower end is then inserted in the embedding hole HA (FIG. 4E).

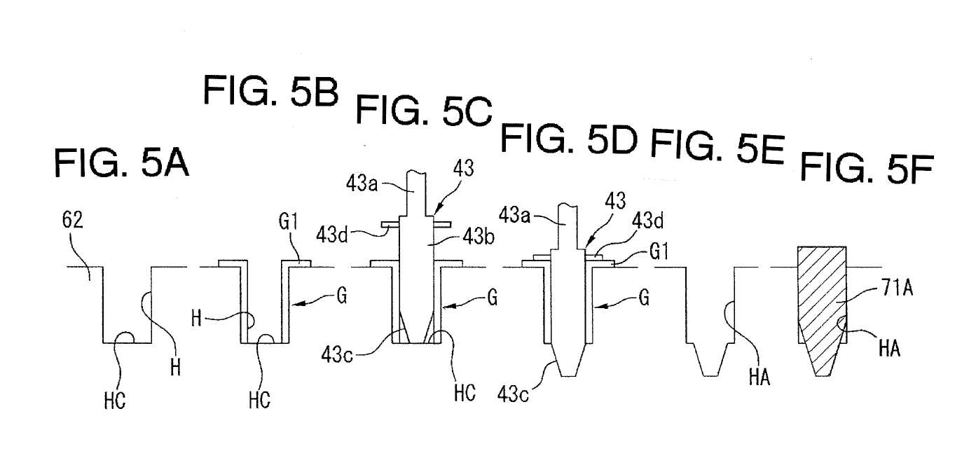

FIG. 5A to FIG. 5F are schematic views illustrating an example in which an embedding hole HA having a truncated cone shaped bottom portion is formed by using a reamer as a device 43.

The device 43 includes a shank portion 43a, a cylindrical portion 43b, and a truncated cone portion 43c. The truncated cone portion 43c becomes a cutting edge used for actual cutting. On the other hand, the outer periphery surface of the cylindrical portion 43b is formed smoothly. The diameter of the outer periphery surface of the cylindrical portion 43b is set to be smaller than a maximum diameter of the base end portion (upper end portion) of the truncated cone portion 43c that becomes the cutting edge. Chippings caused at the truncated cone portion 43c are therefore smoothly ejected through between the alveolar bone 62 and the outer periphery surface of the cylindrical portion 43b.

At the base end portion of the cylindrical portion 43b, a protruding stopper 43d is provided. The device 43 performs cutting by the rotation of a cutting edge. Therefore, if the device 43 is inserted directly in the embedding hole H, the truncated cone portion 43c can inadvertently cut the inner surface of the embedding hole H. Therefore, a cylindrical guide G is used when the device 43 is used. The guide G has a flange portion G1 at its upper end.

The device 43 is attached to a hand piece via the shank portion 43a. The device 43 may be used as described below.

As shown in FIG. 5A, in a case where the device 43 is used, the depth of the embedding hole H, for example, drilled by the drill F (final drill) described above is made shallower than a predetermined depth. This is done because the depth of the embedding hole H after the device 43 is used will become the predetermined depth.

The guide G is inserted in the embedding hole H such that the flange portion G1 of the guide G abuts a surface of the alveolar bone 62 (FIG. 5B).

The device 43 is inserted in inside of the guide G so that the tip of the truncated cone portion 43c abuts the bottom portion HC (FIG. 5C). Cutting starts by rotating the device 43. This condition continues until the stopper 43d abuts the flange portion G1 of the guide G (FIG. 5D). After that, the rotation of the device 43 is stopped, and the device 43 is taken out from the guide G, and then the guide G is taken out from the embedding hole HA. This allows the formation of the embedding hole HA having a truncated cone shaped bottom portion and having a predetermined depth (FIG. 5 E).

The fixture 71A having a truncated cone shaped lower end is then embedded in the embedding hole HA (FIG. 5F).

As described above, the cutting of the alveolar bone can be minimized when an embedding hole HA that has a truncated cone shaped bottom portion being a shape substantially same as that of fixture 71A corresponding to the fixture 71A having a truncated cone shaped lower end is drilled by using the methods as shown in FIGS. 4A to 4E, and FIGS. 5A to 5F.

### Second Embodiment

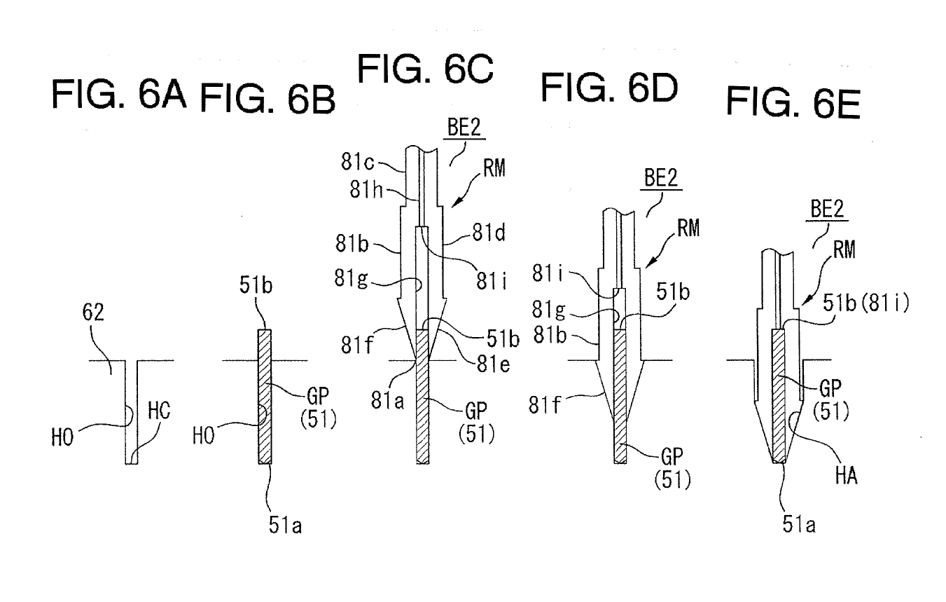

With reference to FIG. 6, a drilling device BE2 according to a second embodiment to which the present invention is applied is described.

The drilling device BE2 of the present embodiment includes a dental reamer RM as a drilling device body and a guide pin GP.

The reamer RM has a cutting portion 81b in a portion nearer a front end 81a and a shank portion 81c in a portion nearer a base end. The cutting portion 81b has a shape substantially same as that of the fixture 71A, and is composed of a cylindrical portion 81d in a portion nearer the base end and a truncated cone portion (tapered portion) 81e in a portion nearer the front end 81a. The truncated cone portion 81e becomes a cutting edge 81 used for actual cutting. On the other hand, the cylindrical portion 81d has a smoothly formed outer periphery surface. The diameter of the outer periphery surface is set to be slightly smaller than a maximum diameter of the base end portion (upper end portion) of the truncated cone portion 81e. Because of the difference in the diameters, chippings caused at the truncated cone portion 81e can be smoothly ejected.

The reamer RM has a central hole 81g in the cutting portion 81b formed from the front end 81a toward the base end. The central hole 81g has a shape and dimension similar to those of the central hole 41e shown in FIG. 1 described above. Explanation thereof is thus omitted.

The reamer RM includes a water injection hole 81h, similar to the water injection hole 41f shown in FIG. 1, formed in the shank portion 81c.

The guide pin GP has a shape and dimension similar to those of the guide pin GP shown in FIG. 1 described above. Explanation thereof is thus omitted.

The drilling device BE2 comprising the reamer RM described above and the guide pin GP may be used substantially similarly to the drilling device BE1 described above, as described below.

An embedding hole H0 of a predetermined depth is drilled in a predetermined direction by a pilot drill (FIG. 6A).

The guide pin GP (guide pin 51) is inserted in the embedding hole H0 (FIG. 6B).

The front end 81a of the central hole 81g of the reamer RM is fitted with a protruding portion of the guide pin GP (FIG. 6C).

With this condition, the reamer RM is rotated to start to ream and gradually deepen the hole (FIG. 6D).

A top surface 81i of the central hole 81g of the reamer RM abuts the base end 51b of the guide pin GP, and thus the drilling (proceeding) of the hole by the reamer RM is stopped (FIG. 6E).

Then, the reamer RM is taken out and the guide pin GP is taken out. This allows the formation of the embedding hole HA having a predetermined depth and having a truncated cone shaped bottom portion.

Since the front end 81a of the reamer RM of the present embodiment is tapered, the bottom portion HC of the embedding hole HA is formed by the reamer RM into a similarly truncated cone (tapered) shape. Therefore, it is not possible to embed the guide pin GP in the embedding hole HA drilled by the reamer RM.

For this reason, the reamer RM can be preferably used in a case where an embedding hole HA having a final shape is drilled directly from the embedding hole H0 that is drilled by a pilot drill as shown in FIG. 6A to FIG. 6E, or in a case where the drill DR shown in FIG. 1 is used to drill the embedding holes H for a hole immediately before the embedding hole HA having a final shape, and then the final embedding hole HA is drilled by the reamer RM.

Using the reamer RM, an embedding hole HA having a truncated cone shaped bottom portion can be formed without using the device 42 described in FIGS. 4A to 4E and the device 43 described in FIGS. 5A to 5F. In other words, the steps in which the devices 42 and 43 are used can be omitted.

### DESCRIPTION OF REFERENCES IN DRAWINGS

41a, 81a Tip of the drill
41b Base end of the drill
41c, 81b Cutting portion
41d, 81c Shank portion
41e, 81g Central hole
41f, 81h Water injection hole
41g Notch
41i, 81f Cutting edge
51a Tip of the guide pin
51b Base end of the guide pin
51c Curved portion
51d Scale
60 Cancellous bone
61 Cortex bone
62 Alveolar bone
70 Implant
71, 71a Fixture
Be1 Drilling device of a first embodiment
Be2 Drilling device of a second embodiment
C Rotation axis
D Predetermined depth of the embedding hole (Depth of the embedding hole H0)
DR1, 2, 3, . . . , F Drill (Drilling device body)
dC Diameter of the central hole
dP Diameter of the guide pin
dW Diameter of the water injection hole
H0 Embedding hole drilled by the pilot drill
H1 Embedding hole drilled by the drill 1
HC Bottom portion of the embedding hole H0
h0 Opening of the embedding hole H0
h1 Opening of the embedding hole H1
hN Opening of the embedding hole HN
LC Length of the central hole
LP Length of the guide pin
GP 51, 52, 53, . . . , 5F Guide pin
RM Reamer (Drilling device body)

1. A drilling device for forming an embedding hole for embedding a fixture of a dental implant is drilled in an alveolar bone of a patient, and used when a hole, which is previously formed by a pilot hole drilling device to a predetermined depth in a predetermined direction, is enlarged stepwise to a predetermined diameter, the drilling device comprises:
a drilling device body having a central hole formed from a front end to a base end along a rotation axis; and
a guide pin inserted in the central hole from the front end;
wherein the guide pin is embedded in the embedding hole formed by the pilot hole drilling device or by a drilling device body in one previous step, and a drilling is performed with the central hole of the drilling device body being fitted with the guide pin, thereby the direction of the drilling is limited to the direction of the guide pin being embedded in.

2. The drilling device according to claim 1, wherein the length of the guide pin is set to a length greater than the depth of the embedding hole previously formed by the pilot hole drilling device.

3. The drilling device according to claim 1, wherein the diameter of the guide pin is set to a magnitude that matches with the diameter of the embedding hole formed by the pilot hole drilling device or by the drilling device body in one previous step.

4. The drilling device according to claim 1, wherein the length of the guide pin is set to a length greater than the length of the central hole.

5. The drilling device according to claim 1, wherein the diameter of the guide pin is set with respect to the diameter of the central hole to allow the guide pin to smoothly slide in the central hole along the rotation axis.

6. The drilling device according to claim 1, wherein a scale is provided on a surface of the guide pin, the scale indicating the length of a portion of the guide pin being embedded in the bone when the guide pin is embedded in the embedding hole.

7. The drilling device according to claim 1, wherein the drilling device body comprises a water injection hole formed along a rotation axis from a base end into the central hole.

8. The drilling device according to claim 1, wherein the drilling device body is a twist drill.

9. The drilling device according to claim 1, wherein the drilling device body is a reamer having a cutting portion that has a shape substantially same as that of the fixture.
